(19) United States
(12) Patent Application Publication
(10) Pub. No.: US 2018/0107961 A1
(43) Pub. Date: Apr. 19, 2018

(54) Task Support System and Task Support Method

(71) Applicant: Hitachi, Ltd., Tokyo (JP)

(72) Inventors: Atsuki KIUCHI, Tokyo (JP); Akihisa TSUJIBE, Tokyo (JP); Yuhei NIWA, Tokyo (JP); Shuangguan HUANG, Sendai (JP); Tazu NOMOTO, Tokyo (JP)

(21) Appl. No.: 15/459,398

(22) Filed: Mar. 15, 2017

(30) Foreign Application Priority Data
Oct. 13, 2016 (JP) 2016-201980

(51) Int. Cl. G06Q 10/06

(52) U.S. Cl. CPC G06Q 10/06315; G06Q 10/06393

(57) ABSTRACT

In a supply chain, an optimal task logic is automatically presented in accordance with a status change occurring in each enterprise in a short time. A task support system generates scenario information of a simulation and generates task logic combining information by combining the scenario information and the task logic of each enterprise. Then, KPI information for each task logic in a scenario is calculated by performing a simulation based on the task logic combining information. Next, status change information relating to a task is read, and a search for a scenario closest thereto is performed. Then, a scenario closest to the status change information is referred to, a KPI relating to the scenario from the KPI information is acquired, a scenario achieving the input importance KPI most is acquired, and a task logic that is combined with the scenario in the task logic combining information is calculated as an optimal task logic.

### TECHNICAL FIELD

The present invention relates to a task support system and a task support method and, more particularly, to a task support system and a task support method that are appropriate for supporting a task by presenting a method of planning an optimal production plan or a method of calculating a safety stock in a supply chain.

### BACKGROUND ART

A supply chain represents a whole series of business processes of a product from procurement of raw materials and components to manufacturing, stock management, selling, and delivery. In operating such a supply chain, it is necessary to instantly select and execute an optimal task logic (a method of planning a production plan or a specific and quantitative method for performing a supply chain task such as a method or calculating a safety stock, which will be describer later) in each enterprise for each status changing from time to time such as a demand. variation or a read time delay due to a disaster. In order to optimally build a supply chain, a technique for evaluating a supply chain through a simulation using a supply chain model is known. As such a technique, for example, there is Patent Document 1. In this Patent Document 1, a technique is disclosed which calculates stocks of products and materials and a distribution route of the procurement of the materials using a simulation using a supply chain model such that a total cost including a stock clearance cost, distribution cost, and a cost of the loss of sales opportunities is minimal as the whole supply chain.

In addition, a technique, while not limited to a supply chain, is known which builds a scenario of an optimal countermeasure for a disaster by correcting a countermeasure direction for a disaster from an actual site in correspondence with an occurring status change. For example, in Patent Document 2, it is described that, in a case where an accumulated value of the degree of certainty of a direction satisfies a predetermined condition, by displaying and correcting a list of directions of which the degree of certainty is determined to be low, “an emergency command support system capable of easily Verifying the optimization of a scenario is provided”.

CITATION LIST

### Patent Document

Patent Document 1: JP 2007-226718 A

Patent Document 2: Jr 2010-204712 A

### SUMMARY OF THE INVENTION

### Problems to be Solved by the Invention

In the technology disclosed in Patent Document 1, a technology is disclosed which calculates a stock of products, a stock of components, and a distribution route of material procurement through a simulator by being triggered upon timing at which a selling plan is updated.

However, in a case where an optima solution is derived from a simulation model, the calculation. resources are limited regardless of a standalone type or a cloud type. In addition, the optimal solution needs to be derived from an assumed demand variation and vast combinations of task logics. Accordingly, there is a problem in that an optimal task logic cannot be calculated at a high speed in accordance with a status change of a supply chain.

In addition in the technology disclosed in Patent Document 2, it is described that, at the time of a disaster, by manually correcting a scenario at the time of the disaster in accordance with a given status change, an optimal emergency scenario can be built.

However, in a case where a status change given, it is not clear whether status changes that may occur sufficiently covered. In addition, since an optimal emergency scenario is manual y derived according to each status change, the accuracy and the calculation time are not clear.

The present invention is for solving the problems described above, and an object thereof is to provide a task support system and a task support method supporting a task by automatically presenting an optimal task logic in a short time in accordance with status change occurring in each enterprise in a supply chain.

### Solutions to Problems

In order to solve problems described above, the configuration of a task support system in a task system configured by a plurality of enterprises includes: a scenario information generating unit that generates scenario information of a scenario in a simulation from master information of each enterprise and a task logic of each enterprise; a task logic combining unit that generates task logic combining information by combining the scenario information generated by the scenario information generating unit and the task logic of each enterprise; a simulation unit that calculates key performance indicator (KPI) information for each task logic in a scenario by performing a simulation based on the task logic combining information; a status change information collecting unit that reads status change information relating to a task of the task system configured by the plurality of enterprises; a similar scenario search unit that acquires a scenario closest to the status change information read by the status change information collecting unit from the task logic combining information; an importance KPI input unit that inputs an importance KPI; an optimal task logic display unit that displays an optimal task logic; and an optimal task logic calculating unit that calculates an optimal task logic of each enterprise. The optimal task logic calculating unit refers to a scenario closest to the status change information, acquires a KPI relating to the scenario from the KPI information, acquires a scenario achieving the input importance KPI most, and calculates a task logic that is combined with the scenario in the task logic combining information as an optimal task logic.

Particularly, the task system configured by the plurality of enterprises may be a supply chain.

### Effects of the Invention

According to the present invention, in a supply chain, a task support system and a task support method supporting a task by automatically presenting an optimal task logic in a short time in accordance with a status change occurring in each enterprise can be provided.

### BRIEF DESCRIPTION OF THE DRAWINGS

FIG. 1 is a configuration diagram of a whole task support system.

FIG. 2 is a hardware configuration diagram of a task support apparatus.

FIG. 3 is a diagram that illustrates an example of an enterprise master information table 1310.

FIG. 4 is a diagram that illustrates an example of an enterprise task logic master information table 1320.

FIG. 5 is a diagram that illustrates an example of an initial scenario information table 1110.

FIG. 6 is a diagram that illustrates an example of a key scenario information table 1140.

FIG. 7 is a diagram that illustrates an example of a scenario information table 1120.

FIG. 8 is a diagram that illustrates an example of a calculation time information table 1150.

FIG. 9 is a diagram that illustrates an example of a task logic combining information table 1130.

FIG. 10 is a diagram that illustrates an example of a KPI calculation result table 1210.

FIG. 11 is a diagram that illustrates an example of a status change information table 1410.

FIG. 12 is a diagram that illustrates an example of a scenario score table 1420.

FIG. 13 is a diagram that illustrates an example of an optimal task logic information table 1430.

FIG. 14 is a flowchart that illustrates a process until a task support system generates learning data through a simulation.

FIG. 15A is a diagram that illustrates an appearance in which a scenario is arranged in association with a demand and a risk (first appearance).

FIG. 15B is a diagram that illustrates an appearance in which a scenario is arranged in association with a demand and a risk (second appearance).

FIG. 16 is a flowchart that illustrates a process of generating an optimal task logic.

FIG. 17 is a diagram that illustrates a user interface screen of a task support system.

### MODE FOR CARRYING OUT THE INVENTION

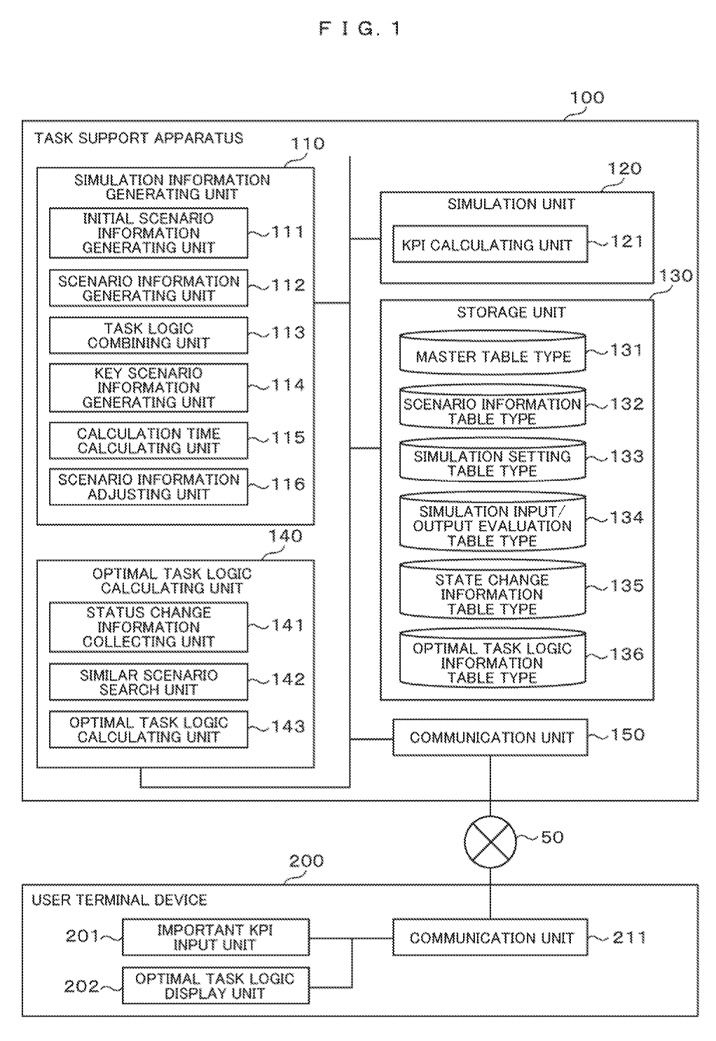

Hereinafter, an embodiment of the present invention will be described with reference to FIGS. 1 to 17.

### [Overview of Task Support System and Terms]

First, for the understanding of a task support system and a task support method according to the present invention, an overview of the system and terms will be described.

A “task logic” according to this embodiment is a specific and quantitative method for performing a supply chain task that can be executed using application software executed on an information processing apparatus such as a computer of the task support system. The task logic according to this embodiment is defined for each enterprise of a supply chain and includes parameters for the execution thereof. More specifically, task logics are a method of planning each of a selling plan, a procurement plan, a production plan, and a supply plan, a planning cycle, a logic for selecting a transportation means, a safe v stock calculating method, and the like.

A “scenario” according to this embodiment is an element describing a status of a simulation executed on an information processing apparatus such as a computer of the task support system and includes a change item and a change value for each product to be handled.

As a variation factor of such a scenario, there is a variation in the demand of a market, a combination of a facility usable status influenced by a disaster and a transportable/non-transportable status, or the like.

In the task support system according to this embodiment, a simulation of a supply chain is executed by inputting information relating to a task logic, information relating to a scenario, a demand, and a parameter that is a risk factor in a supply chain.

In the simulation of the supply chain, key performance indicators (KPI) of a supply chain as a model is output. The KFIs are measured values that assist in defining the degree of attainment of an object of the supply chain and, in this embodiment, are a delivery deadline compliance rate, an inventory money amount, a cash flow (CF), a cash conversion cycle (CCC), and a demand total.

The configuration of the supply chain according to this embodiment can be represented as a graph structure having a plurality of warehouses, factories, and like at intermediate nodes with a supplier set as a start point and a market set as an end point for each product to be handled.

An object of the task support system according to this embodiment is to present a task logic (optimal task logic) that is optimal for each enterprise of the supply chain. At that time, a case where each KPI takes a desirable numerical value is evaluated to be optimal.

Here, an overview of the process until the task support system according to this embodiment requests an optimal task logic will be described.

First, based on master information of each enterprise and information relating to a task logic of the enterprise, an initial scenario is generated.

First, based on the master information of the enterprise and the task logic information of the enterprise, simulations of all the combinations thereof are executed, and the number of scenarios that can be calculated within a predetermined time by an information apparatus that is a target is calculated.

An initial scenario is a scenario that is a seed used for generating subsequent scenarios. The initial scenario is configured by a plurality of scenarios having scenario numbers assigned thereto. In a case where the initial scenario is generated, the initial scenario is generated with a market, which is a terminal node of the configuration of the supply chain, focused. The number of initial scenarios is determined in consideration of the number of scenarios that can be calculated within a predetermined time.

Next, based on the initial scenario, a simulation is executed by combining all the task logics of an enterprise (in other words, an enterprise of a node relating to the market disposed at the terminal) configuring a supply chain of each scenario number, and a KPI in the simulation for each scenario number is calculated.

Next, a KPI score of the simulation of each scenario number is calculated. The KPI score is an indicator acquired by combining KPIs.

Next, a scenario having the initial scenario as a seed is generated. As the generated scenario, a scenario for an enterprise configuring a supply chain of the market of the terminal node is generated. At this time, the scenario is generated such that all the combinations of changed items for each product to be handled are included, and, the change value and the like are generated based on a random number. In addition, the generated scenario includes a scenario number of a related initial scenario. Furthermore, the number of the initial scenario and added scenarios are determined based on the number of scenarios that can be calculated within a predetermined time.

Next, a scenario of which a chance in the KPI score is small is regarded not to be important and is eliminated, and, by changing a parameter from a scenario of which a change in the KPI score is large in correspondence with the elimination, a new scenario is generated and added, whereby the adjustment or scenario is performed.

Next, a simulation is executed based on the initial scenario, the added scenario, the master information of each enterprise, and the information relating to the task logic of the enterprise, and the KPI is recalculated.

Next, a user is caused to input an important KPI (key KPI). Here, being important has a meaning of being seriously regarded in acquiring an optimal task logic.

Next, status change information used for acquiring status change information in the current supply chain is information that has a same data structure as that of the information relating to the scenario. Then, a search for a scenario that is closest (an evaluation or “being close” will be described later) to the generated scenario in the status change information is performed. Then, among task logics used in a simulation according to the scenario number of the scenario, a task logic having a best evaluation of the input important KPI is set as an optimal task logic.

### [Configuration of Task Support System]

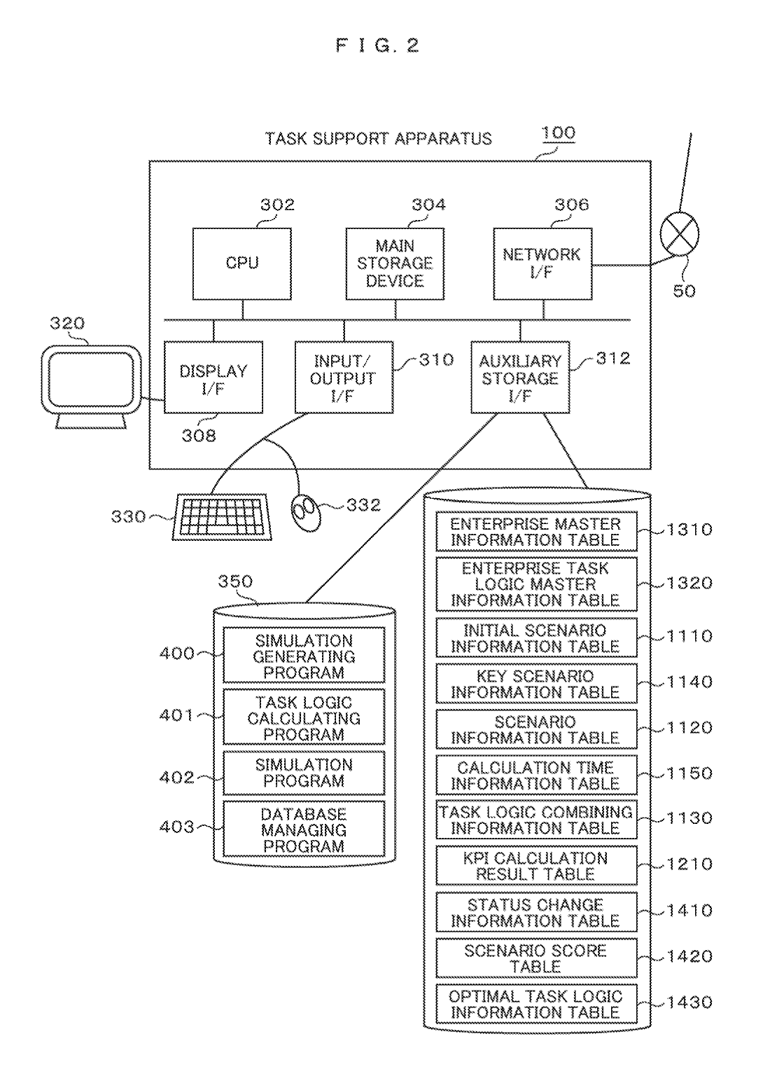

Next, the configuration of the task support system according to this embodiment will be described with reference to FIGS. 1 and 2.

FIG. 1 is a configuration diagram of a whole task support system.

FIG. 2 is a hardware configuration diagram of a task support apparatus.

In the task support system, as illustrated in FIG. 1, a task support apparatus 100 and a user terminal device 200 are interconnected through a network 50.

The task support apparatus 100, when focused on the function, includes functional units of a simulation information generating unit 110, a simulation unit 120, a storage unit 130, an optimal task logic calculating unit 140, and a communication unit 150, and the functional units are interconnected through a communication bus.

The simulation information generating unit 110 is a functional unit that generates information relating to a computer simulation executed by the task support apparatus 100 and includes an initial scenario information generating unit 111, a scenario information generating unit 112, a task logic combining unit 113, a key scenario information generating unit 114, a calculation time calculating unit 115, and a scenario information adjusting unit 116. The initial scenario information generating unit 111 a unit that generates information relating to an initial scenario. The scenario information generating unit 112 is a unit that generates information relating to a scenario (generated based on the initial scenario). The task logic combining unit 113 is a unit that generates information acquired by combining scenario information and a task logic. The key scenario information generating unit 114 is a unit that generates information used for evaluating each scenario. The calculation time calculating unit 115 is a unit that calculates an upper limit of the number of scenarios to be generated by measuring a simulation time. The scenario information adjusting unit 116 is a unit that performs adjustment of the scenario information generated by the scenario information generating unit 112.

The simulation unit 120 is a functional unit that performs a computer simulation of the task support apparatus 100 and includes a KPI calculating unit 121. The KPI calculating unit 121 is a unit that calculates a KPI of each scenario.

The optimal task logic calculating unit 140 is a functional unit that calculates an optimal task logic in consideration of a KPI and includes a status change information collecting unit 141, a similar scenario search unit 142, and an optimal task logic calculating unit 143. The status change information collecting unit 141 is a unit that collects status change information of a supply chain. The similar scenario search unit 142 is a unit that searches for a scenario having status change information that is closest to the status change information collected by the status change information collecting unit 141. The optimal task logic calculating unit 143 is a unit that calculates an optimal task logic based on the important KPI designated by the user.

The storage unit 130 is a unit that stores table data necessary for the task support apparatus 100. Tables stored in the storage unit 130 can be functionally classified into a master table type 131, a scenario information table type 132, a simulation setting table type 133, a simulation input/output evaluation table type 134, a status change information table type 135, and an optimal task logic information table type 136.

The master table type 131 is a table type storing master information of each enterprise configuring the supply chain, and an enterprise master information table 1310 and an enterprise task logic master information table 1320 belong thereto.

The scenario information table type 132 is a table type storing information relating. to a scenario, and an initial scenario information table 1110, a key scenario information table 1140, and a scenario information table 1120 belong thereto.

The simulation setting table type 133 a table type that is necessary for a status setting of a simulation, and a calculation time information table 1150 belongs thereto.

The simulation input/output evaluation table type 134 is a table type that stores input information and output information of a simulation and an evaluation thereof, and a task logic combining information table 1130, a KPI calculation result table 1210, and a scenario score table 1420 belong thereto.

The status change information table type 135 is a tab type that stores status change information of a supply chain, and a status change information table 1410 belongs thereto.

The optimal task logic information table type 135 is a table type that stores optimal task logic information based on the importance KPI input from the user, and an optimal task logic information table 1430 belongs thereto.

Each table will be described later in detail.

The information stored in the storage unit 130 can be acquired through a network or the like, for example, from system such as an enterprise resource planning system, a database storing data according thereto, or data of a simple file format.

The user terminal device 200, focused on the function, is configured by an importance KPI input unit 201, an optimal task logic display unit: 202, and a communication unit 211, and the units are interconnected through a communication bus.

The importance KPI input unit 201 is a unit to which an o importance KPI is input when an optimal task logic is requested from the user. The optimal task logic display unit 202 is a unit that displays information relating to an optimal task logic requested by the task support apparatus 100.

The information relating to the important KPI input from the importance KPI input unit 201 and the information relating to the optimal task logic displayed by the optimal task logic display unit 202 are exchanged with the task support apparatus 100 as the communication unit 211 of the user terminal device 200 includes an interface with the communication unit 150 of the task support apparatus 100.

Here, the communication unit 211 of the user terminal device 200 and the communication unit 150 of the task support apparatus 100 may be local networks or global networks such as the Internet. In addition, the communication form may be wired communication or wireless communication.

The hardware configuration of the task support apparatus 100, for example, is realized by a general personal computer as illustrated in FIG. 2.

The task support apparatus 100 has a form in which a central processing unit (CPU) 302, a main storage device 304, a network I/F 306, c di Splay I/F 308, an input/output I/F 310, and an auxiliary storage I/F 312 are combined through a bus.

The CPU 302 loads a necessary program in the main storage device 304 and executes the program by controlling each unit of the task support apparatus 100.

The main storage device 304, generally, is configured by a volatile memory such as a RAM, and a program executed by the CPU 302 and data referred by Lie program are stored.

The network I/F 306 is an inter ace used for a connection with the network 50.

The display I/F 308 is an interface for a connection with a display device 320 such as a liquid crystal display (LCD).

The input/output I/F 310 is an interface for a connection with an input/output device. In the example illustrated in 2, a keyboard 330 and a mouse 332 of a pointing device are connected thereto.

The auxiliary storage 1/F 312 is an interface for a connection with auxiliary storage devices such as a hard disk drive (HDD) 350, a solid state drive (SSD), and the like.

The HDD 350 has a large storage capacity, and programs and data used for performing this embodiment are stored therein. In the task support apparatus 100, a simulation information generating program 400, a task logic calculating program 401, simulation program 402, and a database managing program 403 are installed.

The simulation information generating program 400, the optimal task logic calculating program 401, and the simulation program 402 are programs respectively executing the functions of the simulation information generating unit 110, the optimal task logic calculating unit 140, and the simulation unit 120 described with reference to FIG. 1. The database managing program 403 is a program used for accessing a database of the task support apparatus 100 and managing the database.

In addition, databases stored in the HDD 350 include an enterprise master information table 1310, an enterprise task logic master information table 1320, an initial scenario information table 1110, a key scenario information table 1140, a scenario information table 1120, a calculation time information table 1150, a task logic combining information table 1130, a KPI calculation result table 1210, a status change information table 1410, a scenario score table 1420, and an optimal task logic information table 1430 as tables.

Each of the tables will be described later detail.

In this embodiment, the programs and the data have been described to be stored in the HDD but may be stored in another storage device such as an SSD.

### [Data Structure of Task Support System]

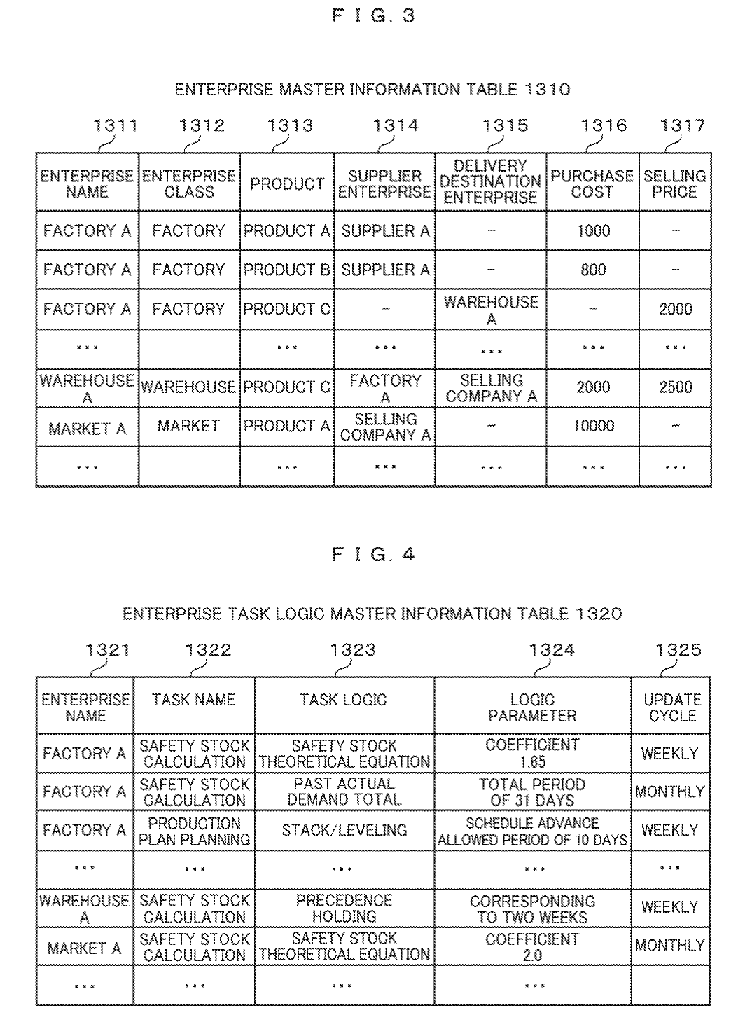

Next, a data structure used in the task support system according to this embodiment will be described with reference to FIGS. 3 to 13.

FIG. 3 is a diagram that illustrates an example of the enterprise master information table 1310.

FIG. 4 is a diagram that illustrates an example of the enterprise task logic master information table 1320.

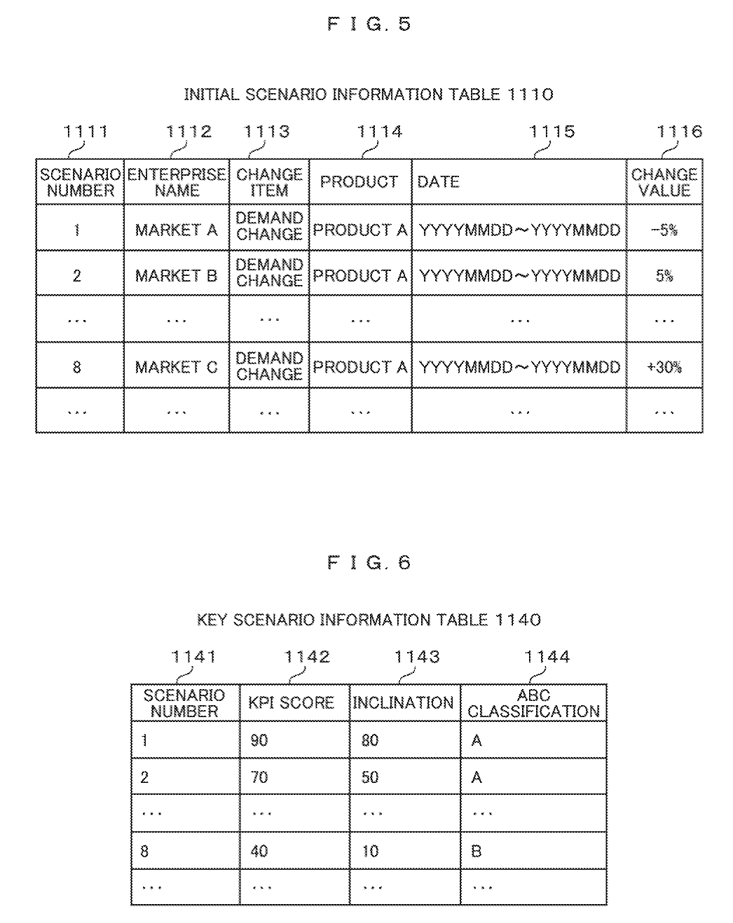

FIG. 5 is a diagram that illustrates an example of the initial scenario information table 1110.

FIG. 6 is a diagram that illustrates an example of the key scenario information table 1140.

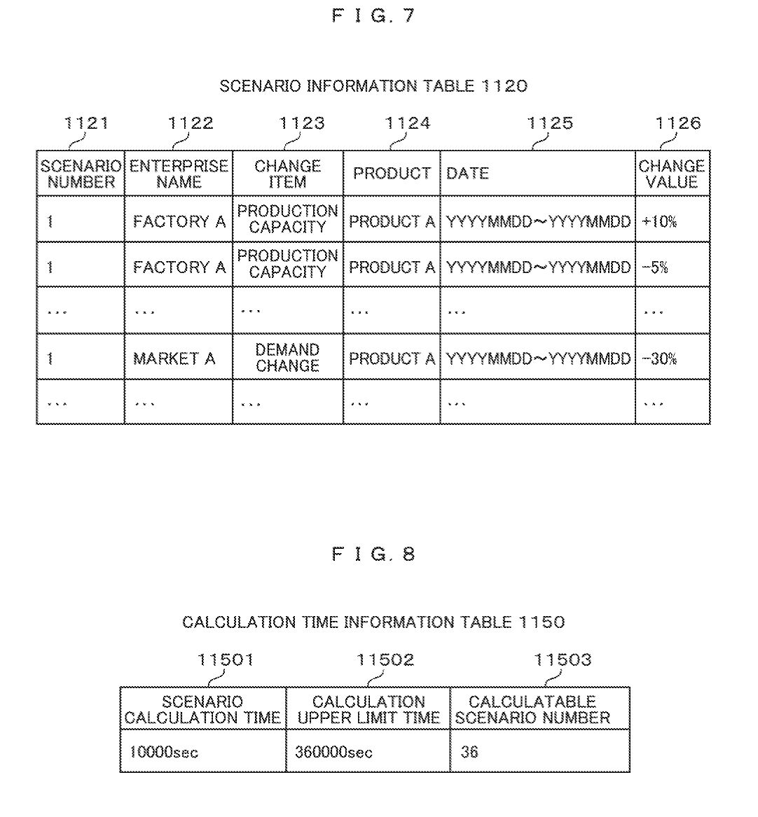

FIG. 7 is a diagram that illustrates an example of the scenario information table 1120.

FIG. 8 is a diagram that illustrates an example of the calculation time information table 1150.

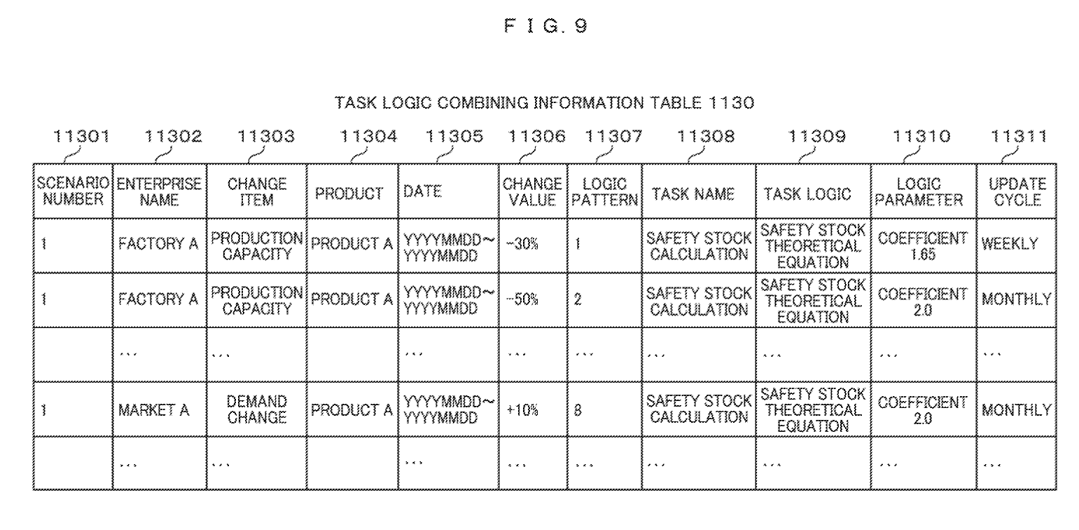

FIG. 9 is a diagram that illustrates an example of the task logic combining information table 1130.

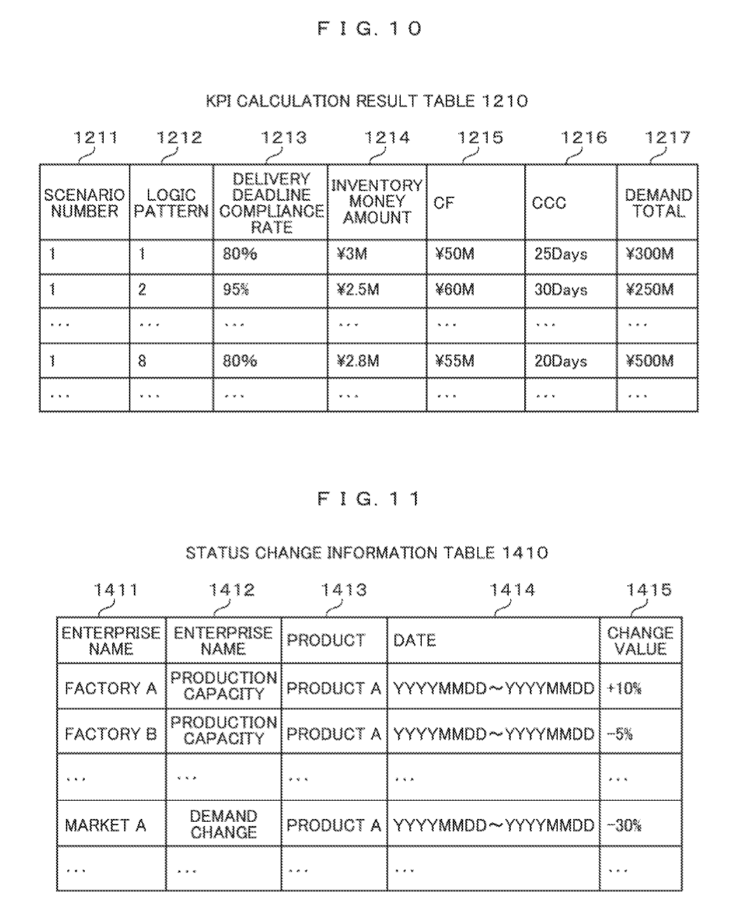

FIG. 10 is a diagram that illustrates an example of the KPT calculation result table 1210.

FIG. 11 is a diagram that illustrates an example of the status change information table 1410.

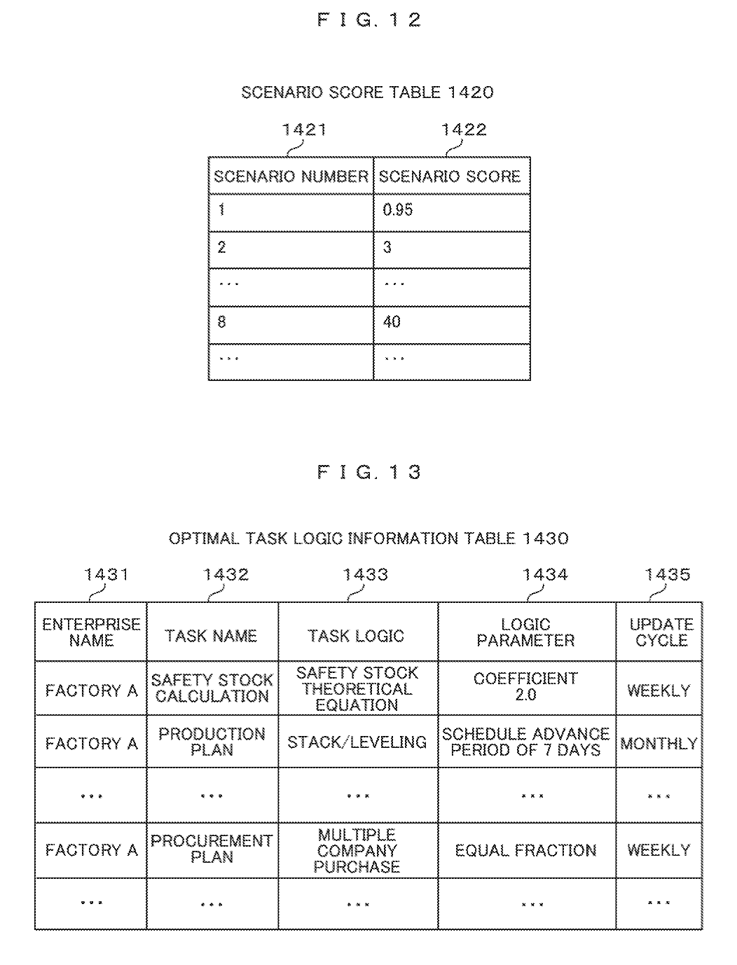

FIG. 12 is a diagram that illustrates an example of the scenario score table 1420.

FIG. 13 is a diagram that illustrates an example of the optimal task logic information table 1430.

The enterprise master information table 1310 is a table in which master information of each enterprise configuring a supply chain is stored. As illustrated in FIG. 3, the enterprise master information table 1310 includes fields of an enterprise name 1311, an enterprise class 1312, a product 1313, a supplier enterprise 1314, a delivery destination enterprise 1315, a purchase cost 1316, and a selling price 1317. In the enterprise name 1311, the name of an enterprise is stored. In the enterprise class 1312, a classification of the enterprise in a supply chain such as “factory”, a “warehouse”, a “market”, or the like is stored. In the product 1313, the name of an object that is a target to be supplied or an identifier is stored. In the supplier enterprise 1314, a destination enterprise from which a product is purchased by the enterprise is stored. In the delivery destination enterprise 1315, a destination enterprise to which the enterprise supplies the product is stored. In the purchase cost 1316, a price at the time of purchasing the product from the supplier is stored. In the selling price 1317, a price at the time of selling the product to the delivery destination is stored.

The enterprise task logic master information table 1320 a table in which information relating to a task logic for each enterprise configuring. a supply chain and, as illustrated in FIG. 4, includes fields of an enterprise name 1321, a task name 1322, a task logic 1323, a logic parameter 1324, and an update cycle 1325. In the enterprise name 1321, the name of an enterprise is stored. In the task name 1322, a task name in which the task logic is used is stored. In the task logic 1323, a name of a corresponding task logic or an identifier is stored. In the logic parameter 1324, the value of a variable parameter of the task logic is stored. In the update cycle 1325, the value of a predetermined update cycle at which the task logic is updated for a review is stored.

The initial scenario information table 1110 is a table in which information relating to an initial scenario is stored and, as illustrated in FIG. 5, includes fields of a scenario number 1111, an enterprise name 1112, a change item 1113, a product 1114, a date 1115, and a change value 1116. In the scenario number 1111, a scenario number that is a number uniquely assigned to each scenario stored. In the enterprise name 1112, a name of an enterprise is stored. In the change item, an item that is a variation factor in the scenario stored. In the change item 1113, an item corresponding to each enterprise class is determined in advance. For example, a variation factor of the class of the market is a “demand change”. In the product 1114, a name of a product relating to the scenario or an identifier is stored. In the date 1115, a date that is a target for a simulation is stored. In the change value 1116, a width of the change in a value corresponding to the content of the change item is stored. For example, in the change value of a change item that is the “demand change”, “−59%” represents that the importance of the product is decreased by 5%.

The key scenario information table 1140 is a table in which information evaluating a scenario is stored for each scenario number and includes fields of a scenario number 1141, a KPI score 1142, an inclination 1143, and an ABC classification 1144.

In the scenario number 1141, a scenario number that is a unique number assigned to each scenario is stored. In the KPI score 1142, a score that is calculated using or a plurality of KPIs is stored. The KPI score according to this embodiment is calculated using the following (Equation 1).

KPI score=(delivery deadline compliance rate x demand total)/(inventory money amount (1)

In the inclination 1143, an indicator representing the amount of change of the scenario number according to change value with respect to previous/following scenario numbers is stored. The inclination is calculated using the following (Equation 2).

Inclination=(KPI score of the scenario number)/(change value of the scenario number−change value of (the scenario number+1) (2)

In the ABC classification 1144, for a scenario of the scenario number, an evaluation at the time or performing an ABC analysis that is a technique for evaluating an important task indicator is stored. In this embodiment, scenarios are ranked as A, B, and C in order of the KPI score.

The scenario information table 1120 is a table storing information relating to a scenario and, as illustrated in FIG. 5, includes fields of a scenario number 1111, an enterprise name 1112, a change item 1113 a product 1114, a date 1115, and a change value 1116. The data structure of the scenario information table 1120 is similar to the initial scenario information table 1110 illustrated in FIG. 5, and the meaning thereof is similar thereto as well. The scenario information table 1120 is a table that includes both a scenario generated from the initial scenario and the initial scenario as records.

In addition, in the change item 1113 of the scenario information table 1120, items of a variation in the demand of a market, a combination of a facility usable status influenced by a disaster and a transportable/non-transportable status, and the like as variation factors for the scenario are stored.

The calculation time information table 1150 a table used for calculating the number of scenarios, used for simulation and storing scenarios corresponding to the upper limit thereof and, as illustrated in FIG. 8, includes fields of a scenario calculation time 11501, a calculation upper limit time 11502, and a calculatable scenario number 11503. In the scenario calculation time 11501, a simulation time calculated based on the enterprise master information table 1310 illustrated in FIG. 3 and the enterprise task logic master information table 1320 illustrated in FIG. 4 is stored. In the calculation upper limit time 1502, a realistic allowed time used for generating learning data for a simulation is stored. In the calculatable scenario number 11503, the number of scenarios that can be calculated calculated casino the following (Equation 3) is stored.

Calculatable scenario number=calculation upper limit time/scenario calculation time (3)

The task logic combining information table 1130 is a table that represents information acquired by combining a task logic represented by the enterprise task logic master information table 1320 illustrated in FIG. 4 and scenarios represented by the initial scenario information table 1110 illustrated in FIG. 4 and the scenario information table 1120 illustrated in FIG. 10 and, as illustrated in FIG. 9, includes fields of a scenario number 11301, an enterprise name 11302, a change item 11303, a product 11304, a date 11305, a change value 11306, a logic pattern 11307, a task name 11308, a task logic 11309, a logic parameter 11310, and an update cycle 11311. Here, the values of the fields of the scenario number 11301 to the update cycle 11311 are input data for a simulation.

The scenario number 11301, the enterprise name 11302, the change item 11303, the product 11304, the date 11305, and the change value 11306 are copied from the scenario number 1111, the enterprise name 1112, the change item 1113, the product 1114, the date 1115, and the change value 1116 of the initial scenario information table 1110 illustrated in FIG. 5 or the enterprise name 1112, the change item 1113, the product 1114, the date 1115, and the change value 1116 of the scenario information table 1120 illustrated in FIG. 10.

The task name 11308, the task logic 11309, the logic parameter 11310, and the update cycle 11311 are copied from the task name 1322, the task logic 1323, the logic parameter 1324, and the update cycle 1325 of the enterprise task logic master information table 1320 illustrated in FIG. 4.

In the logic pattern 11307, a pattern number representing that mutually-different task logics (corresponding to records of the enterprise task logic master information table 1320 illustrated in FIG. 4) are applied to records of the task logic combining information table 1130 having a same scenario number is stored.

The KPI calculation result table 1210 is a table that stores information of each KPI as a result of a simulation for each logic pattern for each scenario number and, as illustrated in FIG. 10, includes fields of a scenario number 1211, a logic pattern 1212, a delivery deadline compliance rate 1213, an inventory money amount 1214, a CF 1215, a CCC 1216, and a demand total 1217.

In the delivery deadline compliance rate 1213, the inventory money amount 1214, the CF 1215, the CCC 1216, and the demand total 1217, information of KPI as a result of each simulation is stored.

The status change information table 1410 is a table that stores a status at a certain time point of a supply chain and, as illustrated in FIG. 11, includes fields of an enterprise name 1411, a change item 1412, a product 1413, a date 1414, and a change value 1415. The data structure of the status change information table 1410 is similar to that of the scenario information table 1120 illustrated in FIG. 7 except for the field of the scenario number, and the meaning thereof similar to that of the scenario information table 1120. However, there is a difference in that each value represents the status at a certain time point of a supply chain that is a target.

The scenario score table 1420 is a table used for storing a scenario score for each scenario number and, as illustrated in FIG. 12, includes fields of a scenario number 1421 and scenario score 1422. In the scenario number 1421, a scenario number that is unique in the task support system is stored. In the scenario score 1422, scenario score of a scenario of the scenario number 1421 stored. The scenario score is an indicator that represents the degree of “being close” from the status change information represented by the status change information table 1410. A method of evaluating this “being close” will be described later in detail.

The optimal task logic information table 1430 table that stores a task logic regarded to be optimal in comparison with results of the simulation and status changes of a certain time point of a supply chain and, as illustrated in 13, includes fields of an enterprise name 1431, a task name 1432, a task logic 1433, a logic parameter 1434, and an update cycle 1435. The data structure of the optimal task logic information table 1430 is similar to that of the enterprise task logic master information table 1320 illustrated in FIG. 4, and the meaning thereof is similar to that of the enterprise task logic master information table 1320. However, there is difference in that each value is a value representing an optimal task logic presented y this task support system.

### [Process of Task Support]

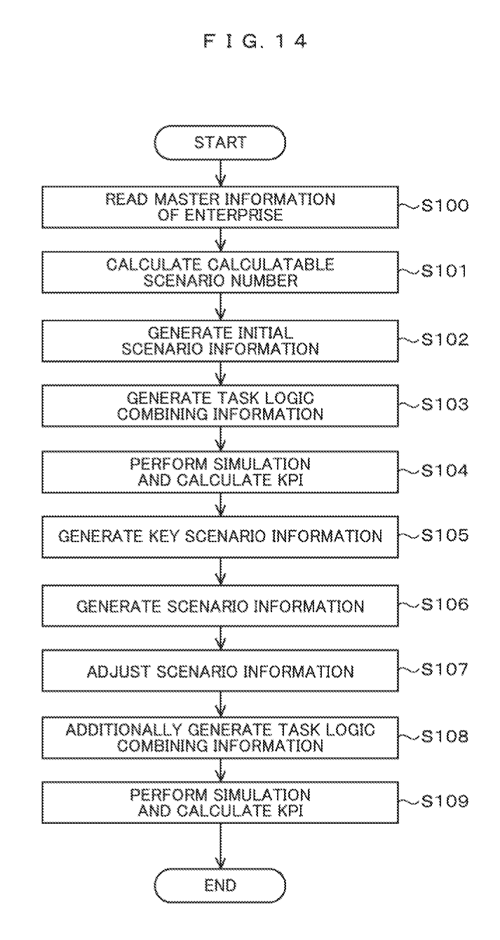

Next, the process of the task support system relating to this embodiment will be described with reference to FIGS. 14 to 17.

(I) Generation of Learning Data through Simulation

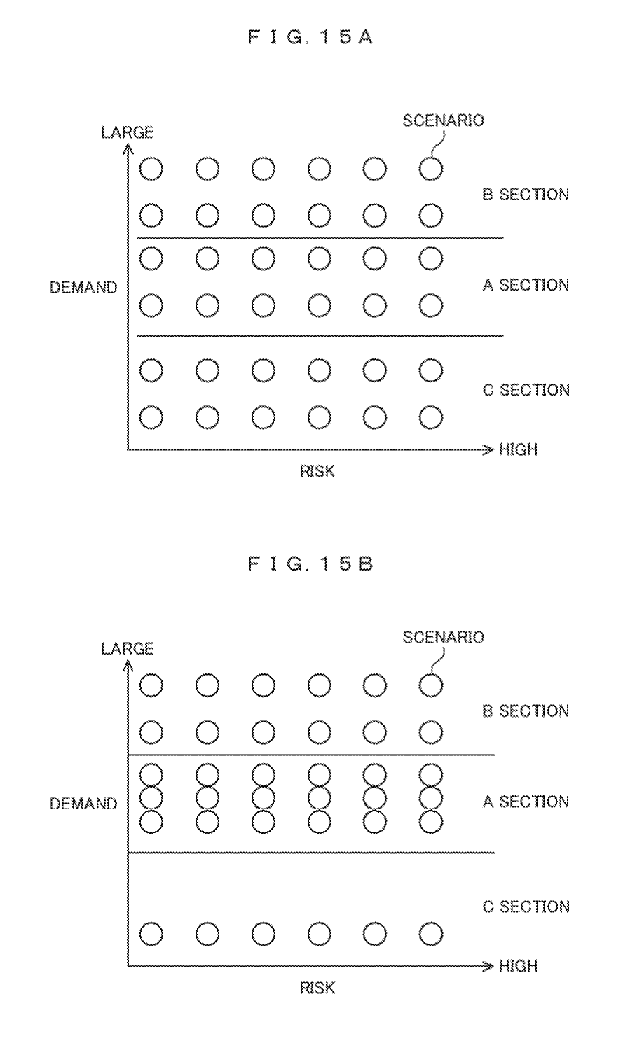

First, the process performed until the task support system generates leaning data through a simulation will be described with reference to FIGS. 14 to 15B.

Here, the learning data through a simulation is data stored in the scenario information table 1120 illustrated in FIG. 7, the task logic combining information table 1130 illustrated in FIG. 9, and the KPI calculation result table 1210 illustrated in FIG. 10.

FIG. 14 is a flowchart that illustrates a process until the task support system generates learning data through a simulation.

FIGS. 15A and 15B are diagrams that illustrate appearances in which a scenario is arranged in association width a demand and a risk.

First, the task support apparatus 100 reads the enterprise master information table 1310 illustrated in FIG. 3 and the enterprise task logic master information table 1320 illustrated in FIG. 4 (S100).

Next, the task support apparatus 100 calculates the number of scenarios that can be calculated by executing a simulation and sets the number of scenarios in the calculation time information table 1150 (S101).

In order to calculate the number of scenarios that can be calculated, the following process is performed. Based on the enterprise master information table 1310 and the enterprise task logic master information table 1320 read in S100, all the combinations of task logics of all the enterprises configuring a supply chain are simulated using a computer that is a target. A combination of enterprises configuring the supply chain is acquired by tracing linkages of the supplier enterprise 1314 and the delivery destination enterprise 1315 illustrated in FIG. 3 for a same product represented by the product 1313. In addition, the data structure of an enterprise configuring the supply chain may be additionally prepared so as to be referred to. A demand amount of a market, a status of facilities, a disaster risk factor, and the like are input to this simulation. At this time, as the demand amount that is input data, a past demand record may be used, or the demand amount may be generated using a normalized distribution, a logistic distribution, or a Poisson distribution.

Next, a total calculation time measured through the simulation is registered in the field of the scenario calculation time 11501 of the calculation time information. table 1150. Here, a value set to the calculation upper limit time 11502 is a calculation time allowed when learning data is generated, and the value may be given as a given time or be input by a user before the generation of learning data from an interface screen (not illustrated in the drawing).

Then, a calculatable scenario number set in the calculatable scenario number 11503 is acquired using (Equation 3) and is set in the field of the calculatable scenario number 11503 of the calculation time information table 1150. In a case a fractional part is acquired according to (Equation 3) , the fractional part is cut off so as form an integer.

Next, the task support apparatus 100 generates initial scenario information (S102). This step is a process performed by the initial scenario information generating unit 111, and the generated initial scenario information is set in initial scenario information table 1110 illustrated in FIG. 5.

The initial scenario information, as described above, is information that becomes a seed so as to generate the scenario information of the scenario information table 1120 illustrated FIG. 7. For this reason, the market that is the terminal node of the supply chain will be focused. For this reason, a search for records matching a “market” among enterprise classes (in this example, a market, a selling company, a warehouse, a factory, a supplier, and a carrier) stored in the field of the enterprise class 1312 the enterprise master information table 1310 is performed. Next, the change value 1116 is generated in a pitch width of a predetermined amount with dates 1115 corresponding to she number of records corresponding to the search being from the start date to the end date of the simulation (for example, from one year before the current date to the current date).

Here, as the pitch width of the predetermined amount, a standard deviation of past demand records may be used, or may be configured such that a demand record is generated in a pseudo manner by using a normal distribution, a logistic distribution, or a Poisson distribution, and a standard deviation of such a distribution is be used as the pitch width. The change item 1113 of the initial scenario information table 1110 is a “demand change”, and the change value 1116 represents a demand in the market. A total number of records (since one initial scenario information corresponds to one scenario scenario number, the number of records matching the scenario number) of the generated initial scenario information. table 1110 is the ½-th power (square root) (a fractional part is cut off) of the value stored in the calculatable scenario number 11503. Here, the reason for using the ½-th power of the value stored in the calculatable scenario number 11503 is to perceive two parameter factors of a parameter of a demand in the market and a parameter of an enterprise other than the market as variation parameters of the simulation, and it relates to the generation of the scenario information table 1120 illustrated in FIG. 7 to be described later (details thereof will be described later).

Next, the task logic combining information is generated (S103).

This step is a process performed by the task logic combining unit 113, and the generated task logic combining information is set in the task logic combining information table 1130 illustrated in FIG. 9.

In other words, the task logic combining unit 113, based on the enterprise master information table 1310 and the enterprise task logic master information table 1320 read in Step S100 and the initial scenario information table 1110 generated in Step S101, generates information set in the task logic combining information table 1130 illustrated in FIG. 9.

The information set in the task logic combining information table 1130 is acquired as below. For each scenario number 1111 of the initial scenario information table 1110 illustrated in FIG. 5 that is set in Step S101, by combining records of the enterprise task logic master information table 1320 illustrated in FIG. 3, a combination pattern of all the task logics for each initial scenario used by each enterprise is generated. Then, as the value of the scenario number 11301 of the task logic combining information table 1130, the value of the scenario number 1111 of the combined initial scenario information table 1110 is registered. The value set in the logic pattern 11307 is a number originated from the enterprise task logic master information table 1320, and, for each scenario number 1111, a different value is assigned to a different record of the enterprise task logic master information table 1320 that is combined. The other parts, the enterprise name 11302, the change item 11303, the product 11304, the date 11305, and the change value 11306 are respectively copied from the enterprise name 1112, the change item 1113, the product 1114, the date 1115, and the change value 1116 of the scenario information table 1120 illustrated in FIG. 10, and the task name 11308, the task logic 11309, the logic parameter 11310, and the update cycle 11311 are respectively copied from the task name 1322, the task logic 1323, the logic parameter 1324, and the update cycle 1325 of the enterprise task logic master information table 1320 illustrated in FIG. 4, which has been described above.

Next, based on the generated task logic combining information, a simulation is executed for all the scenario number, and a KPI for each logic parameter is calculated (S104).

This step is a process performed by the simulation unit 120, and the calculated KPI for each logic parameter is set in the KPI calculation result table 1210 illustrated in FIG. 10.

Next, the key scenario information is generated (S105).

This step is a process performed by the key scenario information generating unit 114, and the generated key scenario information is set in the key scenario information table 1140 illustrated in FIG. 11.

The key scenario information is acquired as below.

First, for each KPI (the values of the delivery deadline compliance rate 1213, the inventory money amount 1214, the CF 1215, the CCC 1216, and the demand total 1217) of the KPI calculation result table 1210 illustrated in FIG. 10, an arithmetic mean of logic patterns belonging to the scenario number of the scenario number 1211 is taken and is set as the value of the KPI for the scenario number.

Then, for each scenario number, by using (Equation 1), a KPI score is acquired and is set as the KPI score set in the KPI score 1142 for the scenario number. Next, for each scenario number, by using (Equation 2), an inclination acquired and is set as an inclination set in the inclination. 1143.

Then, scenarios of the scenario numbers, based on the ABC analysis, are ranked to A, B, and C and are set in the field of the ABC classification 1144.

Next, the scenario information is generated (S106).

This step is a process performed by the scenario information generating unit 112, and the generated scenario information is set in the scenario information table 1120 illustrated in FIG. 7.

The scenario information set in the scenario information table 1120 is acquired as below.

First, records of the initial scenario information table 1110 illustrated in FIG. 5 are copied to the scenario information table 1120.

Next, among the enterprise classes 1312 of the enterprise master information table 1310, in a same supply chain, the values of the set enterprise classes are randomly selected from the enterprise name 1311 such that at least one or more of each enterprise class other than the market are selected. The date 1125 and the change value 1126, for example, are selected using a uniform random number. The change item 1123 and the product 1124 uniformly selected from all the change items (in this example, a demand change, a production capacity, a production lead time, and a transportation lead time) and all the products such that at least one or more of each thereof are included.

Next, the enterprise name 1311, the change item 1123, the product 1124, the date 1125, and the change value 1126 of the enterprise master information table 1310 and each scenario number 1111 of the initial scenario information table 1110 are combined and are added to the end of the scenario information table 1120 as new records. The upper limit of the new additional records is a value acquired by subtracting the number (the ½-th power of the value of the calculatable scenario number 11503) of the scenario numbers of the initial scenario information table 1110 from the value of the calculatable scenario number 11503 of the calculation time information table 1150 illustrated in FIG. 8. In other words, in this way, the number scenarios represented by the scenario information table 1120 is suppressed to the value of the calculatable scenario number 11503.

Next, the adjustment of the scenario information is performed (S107).

This step is a process performed by the scenario information adjusting unit 116.

In this embodiment, an example will be described in which a part of scenarios classified into the C class by the key scenario information is removed, and scenarios corresponding to the number of the removed scenarios are added to the A class. The reason for this is that a scenario ranked to the A class is a scenario having a large inclination, a simulation employing the scenario has a large change in the KPT score, and an effective simulation is estimated to be executed.

Here, when each scenario is evaluated by setting the demand of the market of the parameter of the scenario to the vertical axis and setting the risk of a decrease in the production capacity of the factory to the horizontal axis, a drawing as illustrated in FIG. 15A is acquired. In other words, two-dimensional mapping of the demand of the market of the parameter and the risk of the decrease in the production capacity of the factory is formed. This is the reason why the scenario information is generated with the number of the scenario numbers of the initial scenario information table 1110 as the ½-th power of the value of the calculatable scenario number 11503.

First, among C classes of the ABC classification 1144 of the key scenario information table 1140, in order of the lowest to highest inclination 1143, records of the scenario number 1121 are removed from the C class. For example, the number of records to be removed is a half (in the case of an odd number, the value is rounded down) of the number of records of the C class. Then, a total number of the removed scenarios is set as an addable scenario number.

Next, scenarios corresponding to the addable scenario number are additionally generated as scenarios corresponding to the A class of the ABC classification 1144. For example, in order of the highest to lowest inclination 1143 of scenarios of the A class, the scenario and, from a normal random number having the change values 1116 of the other scenario numbers 1121 completely including the enterprise name 1122 to the change value 1126 as the mean and having a standard deviation of “1”, a record of the change value 1125 are additionally generated. In a case where all the scenarios of the A class are selected as the reference, again, a record is additionally generated from a scenario having a highest inclination 1143.

At this time, the additionally generated record is added to the end of the scenario information table 1120 as a new record to which a new scenario number is assigned.

FIG. 15B is a diagram that illustrates an example of a case where the number scenarios the class are decreased to be a half, and scenarios of the A class additionally generated.

Next, the task logic combining information is additionally generated (S108).

This is a process in which the task logic combining unit 113 additionally generates information set in the task logic combining information table 1130 illustrated in FIG. 9 based on. the scenario information table 1120 adjusted in Step S107.

A method of setting in the task logic combining information table 1130 conforms to the method of generating the task logic combining information table 1130 of S103.

In other words, for a scenario number of each scenario number 1121 of the scenario information table 1120 illustrated in. FIG. 7 that is generated in Step S100 and is adjusted in Step S107, the enterprise task logic master information table 1320 illustrated in FIG. 4 is combined. The combinations of the task logic combining information table 1130 are all the combinations or the task logics of each enterprise. Then, as the scenario number 11301 of the task logic combining information table 1130, the scenario number 1121 of the combined scenario information table 1120 is registered. As the logic pattern 11307, for each scenario number 1121, combination of one record of the enterprise task logic master information table 1320 is registered as a unique number.

Next, based on the additionally-generated task logic combining information, a simulation is executed for all the scenario numbers, and a KPI for each logic parameter is calculated (S107).

This step is a process performed by the simulation unit 120, and the calculated. KPI for each logic parameter is set in the KPI calculation result table 1210 illustrated in FIG. 10.

### (II) Generation of Optimal Task Logic

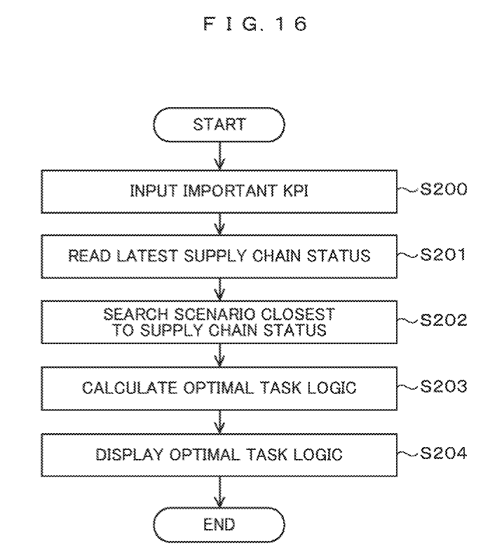

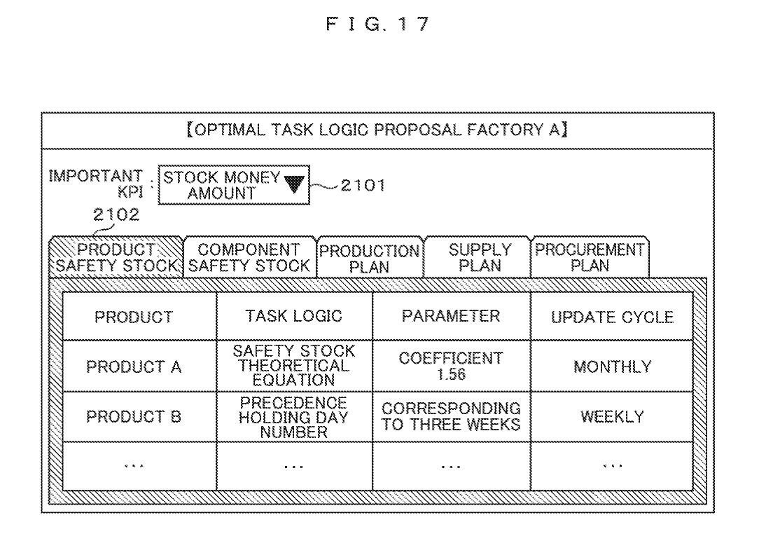

Next, a process performed until an optimal task logic is generated from learning data acquired through a simulation and the current status of a supply chain will be described with reference to FIGS. 16 and 17.

FIG. 16 is a flowchart that illustrates a process or generating an optimal task logic.

FIG. 17 is a diagram that illustrates a user interface screen of a task support system.

First, a user inputs an importance KPI that is an indicator used for evaluating an optimal task logic from the user interface screen 2100 of the user terminal device 200 (S200).

This step is performed by the importance KPI input unit 201 of the user terminal device 200.

The user interface screen 2100, as illustrated in FIG. 17, includes an importance KPI input field 2101 and an optimal task logic display field 2102, and an importance KPI is selected from the importance KPI input field 2101.

The importance KPI selection field 2101 is configured as a combo box in which the delivery deadline compliance rate, the inventory money amount, the CF, and the CCC as KPIs according to this embodiment are displayed as options.

A content received into the importance KPI selection field 2101 is transmitted to the task support apparatus 100 through the communication unit 211, the network 50, and the communication unit 150.

Next, the task support apparatus 100 reads the latest status of the supply chain (Step S201).

This step is a process that is performed by the status change information collecting unit 141 of the optimal task logic calculating unit 140.

The timing at which the latest status of the supply chain is read by the task support apparatus 100 is timing at which the content of the importance KPI is transmitted. In addition, the timing at which the status of the supply chain is read may be configured to be settable by the user.

The status change information collecting unit 141 of the optimal task logic calculating unit 140 acquires information of the current state of the supply chain from a system such as an ERP, a database in which data conforming thereto is stored, and the like at the timing at which the content of the importance is transmitted and sets the acquired information in the status change information table 1410.

In addition, the change value 1415 is acquired from a journal of a database or the like at the time of performing the process of Step S102 illustrated in FIG. 14 by performing a comparison using the demand amount, the production amount, or the like of a corresponding product as the reference.

Next, the task support apparatus 100 searches for a scenario closest to the read status of the supply chain.(S202).

This step is a process performed by the similar scenario search unit 142. The similar scenario search unit 142 searches for a scenario that is closest to the information stored in the status change information tab 1410 generated in. Step S201 from the task logic combining information table 1130.

The scenario that closest to the information stored in the status change information table 1410 is acquires as below.

The enterprise name 1411, the change item 1412, and the product 1413 of each record of the status change information table 1410 are acquired. Next, for each scenario number 11301 of the task logic combining information table 1130 illustrated in FIG. 9, the number of all the records completely matching the enterprise name 11302, the change item 11303, and the product 11304 is acquired, and a value acquired by dividing the acquired number of the records by the number of records of the scenario number 11301 set as record score. In other words, the record score is acquired using the following (Equation 4).

Record score of the scenario of the scenario number=(the number of all the records completely matching enterprise name, the, change item, and the product)/(the number of all the records of the scenario number) (4)

This record score is an indicator that represents the degree of matching of the scenario represented by the scenario number 11301 as a “record” and has a meaning that, as the scenario represented by the scenario number 11301 has a higher degree of matching, the record score further approaches “1”.

Next, among the records completely matching the enterprise name 11302, the change item 11303, and the product 11304, the change rate of each of all the combinations of date 1305, the change value 11306, the date 1414, and the change value 1415 is calculated, and an arithmetic mean is calculated. In this example, the date is calculated using the change rate of date, and the change value is set as the change rate of the value. Then, an arithmetic mean of arithmetic means of the change rates of the date and the change value is calculated and is set as a parameter score. In other words, the parameter score is acquired using the following (Equation 5).

D=(Σ Change rate of date 11306)/(Change rate of date 1414)) For all combinations/Number of combinations

(Σ Change value 11306)/(Change value 1415)) For all combinations/Number of combinations

Parameter score=(D+V)/2 (5)

This parameter score is an indicator representing the degree of matching of the scenario represented by the scenario number 11301 as a “parameter” among the records completely matching the enterprise name 11302, the change item 11303, and the product 11304 and has a meaning that that the parameter score further approaches “1” as the scenario is represented by a scenario number 11301 having a higher degree of matching.

Then, an arithmetic mean of the parameter score and the record score is set as a scenario score. In other words, the scenario score is acquired using the following (Equation 6).

Scenario score=(record score+parameter score)/2 (6)

Hereinafter, a specific example will be described. For example, for a scenario number 11301 having a total record number 20, it is assumed that there are two records completely matching the enterprise name 11302, the change item 11303, and the product 11304. In addition, the dates and the change values of the two records completely matching the enterprise name 11302, the change item 11303, and the product 11304 are respectively 3 days and 10 days and 30% and 10%, and the dates and the change values of the status change information table 1410 are respectively 5 days and 2 days and 10% and 30%.

At this time, the record score is 2/20=1/10, and the parameter score =(D+V)/2, (3/5+10/2+3/2+10/5)/4), (30/10+10/30+30/30+10/10)/4), and the parameter score=433/240, and the scenario score is (1/10+433/240)/2 which is about 0.95.

This scenario score is a value that evaluates the degree of matching of scenarios from both viewpoints of the degree of matching of records and the degree of matching of parameters.

Then, the similar scenario search unit 142 stores the scenario score for the scenario number in the field of the scenario score 1422 of the scenario score table 1420 illustrated in FIG. 12.

Then, the scenario score is calculated for each of all the scenario numbers 11301, and a scenario number having a scenario score closest to “1” is selected from the scenario number 11301. Then, the scenario of the scenario number is set as a scenario closest to the information stored in the status change information table 1410.

Next, an optimal task logic is calculated (S203).

This step is a process performed by the optimal task logic calculating unit 143.

The optimal task logic calculating unit 143 calculates the optimal task logic and sets the calculated optimal task logic in the optimal task logic information table 1430 illustrated in FIG. 13.

The calculation of the optimal task logic is performed as below.

The optimal task logic calculating unit 143, by using the scenario number of the scenario closest to the information stored in the status change information table 1410 selected in Step S202, a search for the corresponding scenario number is performed from the scenario number 1211 of the KPI calculation result table 1210, and, among the scenario numbers, a search n for a logic pattern 1212 achieving the important KPI input by the user most is performed. For example, among KPIs, delivery deadline compliance rate closest to 100%, a small inventory money amount, a large CF, a short CCC may be regarded as achieving each KPI.

Then, thereof is set in the optimal task logic information table 1430.

Next, the optimal task logic is displayed by the user terminal device (S204).

The task support apparatus 100 transmits the information stored in the optimal task logic information table 1430 set in Step S203 to the user terminal device 200 through the communication unit 150, the network 50, and the communication unit 211.

The optimal task logic display unit 202 of the user terminal device 200 displays the transmitted information in the optimal task logic display field 2102 of the user interface screen 2100. In this way, the user can easily perceive the optimal task logic in the current supply chain and the optimal parameter.

1. A task support system in a task system configured by a plurality of enterprises, the task support system comprising:
a scenario information generating unit that generates scenario information of a scenario in a simulation from master information of each enterprise and a task logic of each enterprise;
a task logic combining unit that generates task logic combining information by combining the scenario information generated by the scenario information generating unit and the task logic of each enterprise;
a simulation unit that calculates key performance indicator (KPI) information for each task logic in a scenario by performing a simulation based on the task logic combining information;
a status change information collecting unit that reads status change information relating to a task of the task system configured by the plurality of enterprises;
a similar scenario search unit that acquires a scenario closest to the status change information read by the status change information collecting unit from the task logic combining information;
an importance KPI input unit that inputs an importance KPI;
an optimal task logic display unit that displays an optimal task logic; and
an optimal task logic calculating unit that calculates an optimal task logic of each enterprise,
wherein the optimal task logic calculating unit refers to a scenario closest to the status change information, acquires a KPI relating to the scenario from the KPI information, acquires a scenario achieving the input importance KPI most, and calculates a task logic that is combined with the scenario in the task logic combining information as an optimal task logic.

2. The task support system according to claim 1, wherein the task system configured by the plurality of enterprises is a supply chain.

3. The task support system according to claim 1, wherein the task logic includes a planning method and a planning cycle of each of a selling plan, a procurement plan, a production plan, and a supply plan, a carrier unit selecting logic, and safety stock calculating method and a calculation cycle.

4. The task support system according to claim 1, wherein an item of a combination of a demand variation in a market, a facility usable status influenced. by a disaster, and a transportable/non-transportable status is included as a change item of the scenario.

5. The task support system according to claim 1, wherein the KPI enables two or more of a delivery deadline compliance rate, an inventory money amount, a cash flow (CF) , a cash conversion cycle (CCC), and a demand total to be selected.

6. The task support system according to claim 1, wherein, for each scenario, a KPI score acquired by combining a plurality of the KPis is calculated, and, in accordance with a degree of importance according to the KPI score, the scenario information is removed or addltionally generated.

7. The task support system according to claim 1, wherein a scenario closest to the status change information read by the status change information collecting unit is calculated from a record score evaluating matching of a record with the task logic combining information and a parameter score evaluating matching of a parameter in the record.

8. A task support method in a task system configured by a plurality of enterprises, the task support method comprising:
generating scenario information of a scenario in a simulation from master information of each enterprise and a task logic of each enterprise;
generating task logic combining information by combining the scenario information generated in the generating of scenario information and the task logic of each enterprise;
calculating key performance indicator (KPI) information for each task logic in a scenario by performing a simulation based on the task logic combining information;
reading status change information relating to a task or the task system configured by the plurality of enterprises;
acquiring a scenario closest to the status change information read in the reading of status change information from the task logic combining information;
inputting an importance KPI;
displaying an optimal task logic; and
calculating an optimal task logic of each enterprise,
wherein, in the calculating of an optimal task logic, a scenario closest to the status change information is referred to, a KPI relating to the scenario is acquired from the KPI information, scenario achieving the input importance KPI most is acquired, and a task logic that is combined with the scenario in the task logic combining information is calculated as an optimal task logic.

9. The task support method according to claim 8, wherein the task system configured by the plurality of enterprises is a supply chain.

10. The task support method according to claim 9,
wherein the generating of scenario information includes:
generating scenario information of an enterprise that is a market in a supply chain; and
additionally generating scenario information of other enterprises relating to each market.

11. The task support method according to claim 10, wherein the number of scenarios in the generating of scenario information is a number not exceeding the ½-th power of the number of scenarios that can be calculated.
